(19) United States
(12) Patent Application Publication
(10) Pub. No.: US 2006/0088696 A1
(43) Pub. Date: Apr. 27, 2006

(54) Reinforced fibrous structures

(75) Inventors: John Allen Manifold, Milan, IN (US); Douglas Jay Barkey, Maineville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/242,446

(22) Filed: Oct. 3, 2005

Related U.S. Application Data
(60) Provisional application No. 60/621,811, filed on Oct. 25, 2004.

(51) Int. Cl. B32B 1/00

(52) U.S. Cl. 428/174

(57) ABSTRACT

Fibrous structures that comprise a CD knuckle and/or that exhibit a product of caliper and CD modulus of at least about 10,000 and/or that exhibit a ratio of CD modulus to caliper of at least about 35, and methods for making such fibrous structures are provided.

### CROSS REFERENCE TO RELATED APPLICATION

This application claims the benefit of U.S. Provisional Application No. 60/621,811 filed on Oct. 25, 2004.

### FIELD OF THE INVENTION

The present invention relates to fibrous structures and sanitary tissue products comprising fibrous structures and methods for making same. More particularly, the present invention relates to fibrous structures that comprise a CD knuckle and/or that exhibit a product of caliper and CD modulus of at least about 10,000 and/or that exhibit a ratio of CD modulus to caliper of at least about 35, and methods for making such fibrous structures.

### BACKGROUND OF THE INVENTION

Softness, strength and/or absorbency are properties that consumers need in fibrous structures and/or sanitary tissue products comprising fibrous structures.

Formulators, especially through-air dried fibrous structure formulators, have tried to meet the consumers' needs by increasing the caliper (the apparent thickness) of fibrous structures. Such prior art products provide increased caliper and result in increased softness, which consumers like, but also results in decreased CD modulus, which causes handling issues during the making of the fibrous structures and/or sanitary tissue products comprising such fibrous structures.

Accordingly, there is a need for fibrous structures and methods for making such fibrous structures that exhibit sufficient caliper that meets the consumers' needs without negatively impacting the handling of the fibrous structures and/or sanitary tissue products during the making of such fibrous structures and/or sanitary tissue products, as a result of negatively impacting the CD modulus of the fibrous structures.

### SUMMARY OF THE INVENTION

The present invention fulfills the needs described above by providing fibrous structures that comprise a CD knuckle and/or that exhibit a product of caliper and CD modulus of at least about 10,000 and/or that exhibit a ratio of CD modulus to caliper of at least about 35, and methods for making such fibrous structures.

In one example of the present invention, a fibrous structure comprising:

a. a network region; and

b. a dome region;

wherein the network region comprises a CD knuckle, is provided.

In another example of the present invention, a fibrous structure comprising a caliper and a CD modulus such that the product of the caliper and the CD modulus is greater than about 10,000 and/or greater than about 15,000 and/or greater than about 20,000 and/or greater than about 25,000 and/or greater than about 30,000 and/or greater than about 33,000 and/or greater than about 35,000, is provided.

In still another example of the present invention, a fibrous structure that exhibits a ratio of CD modulus to caliper of at least about 35 and/or at least about 45 and/or at least about 55 and/or at least about 65 and/or at least about 75, is provided.

In yet another example of the present invention, a single- or multi-ply sanitary tissue product comprising a fibrous structure according to the present invention, is provided.

In even yet another example of the present invention, a method for making a fibrous structure comprising the step of forming a fibrous structure comprising a network region and a dome region, wherein the network region comprises a CD knuckle, is provided.

### BRIEF DESCRIPTION OF THE DRAWINGS

FIG. 1 is a plan view of one example of a fibrous structure in accordance with the present invention;

FIG. 2 is a cross sectional view of the fibrous structure shown in FIG. 1 taken along line 2-2;

FIG. 3 is a schematic representation of one example of a fibrous structure making machine useful in the practice of the present invention;

FIG. 4 is a plan view of a portion of deflection member useful in the practice of the present invention; and

FIG. 5 is a cross sectional view of the deflection member shown in FIG. 4 taken along line 5-5.

### DETAILED DESCRIPTION OF THE INVENTION

“Fibrous structure” and/or “Web” as used herein means a substrate formed from non-woven fibers. The fibrous structure of the present invention may be made by any suitable process, such as wet-laid, air-laid, spunbond processes. The fibrous structure may be in the form of one or more plies suitable for incorporation into a sanitary tissue product and/or may be in the form of non-woven garments, such as surgical garments including surgical shoe covers, and/or non-woven paper products such as surgical towels and wipes.

An embryonic fibrous web can be typically prepared from an aqueous dispersion of fibers, though dispersions in liquids other than water can be used. Such a liquid dispersion of fibers is oftentimes called fibrous slurry. The fibers can be dispersed in the carrier liquid to have a consistency of from about 0.1% to about 0.3%. It is believed that the present invention can also be applicable to moist forming operations where the fibers are dispersed in a carrier liquid to have a consistency less than about 50%, more preferably less than about 10%.

Alternatively, an embryonic fibrous web can be prepared using air laid technology wherein a composition of fibers, (not typically dispersed in a liquid) are deposited onto a surface, such as a forming member, such that an embryonic web is formed.

The fibrous structures of the present invention may have physical properties, such as dry tensile strength, wet tensile strength, caliper, basis weight, density, opacity, wet burst, decay rate, softness, bulk, lint and sidedness suitable to consumers for fibrous structures used in sanitary tissue products and/or known by those skilled in the art to be suitable for fibrous structures used in sanitary tissue products.

“Fiber” as used herein means an elongate particulate having an apparent length greatly exceeding its apparent width, i.e. a length to diameter ratio of at least about 10. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers such as rayon and other polymeric fibers such as polypropylene, polyethylene, polyester, polyolefin, polyethylene terephthalate and nylon and various hydroxyl polymers, can be used. The polymeric fibers can be produced by spunbond processes, meltblown processes, and other suitable methods known in the art.

The fibers may be short or long (e.g., NSK fibers). Nonlimiting examples of short fibers include fibers derived from a fiber source selected from the group consisting of Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, Magnolia, Bagasse, Flax, Hemp, Kenaf and mixtures thereof.

“Fibrous furnish” as used herein means a composition of fibers. In one example, the fibrous furnish may comprise fibers and a liquid, such as water.

“Sanitary tissue product” as used herein means a single- or multi-ply wiping implement for post-urinary and post-bowel movement cleaning (toilet tissue), for otorhinolaryngological discharges (facial tissue), and multi-functional absorbent and cleaning uses (absorbent towels).

The sanitary tissue products of the present invention may have physical properties, such as dry tensile strength, wet tensile strength, caliper, basis weight, density, opacity, wet burst, decay rate, softness, bulk, lint and sidedness suitable to consumers for use as sanitary tissue products and/or known by those skilled in the art to be suitable for use as sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²) is measured. The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Dry Tensile Strength” (or simply “Tensile Strength” as used herein) of a fibrous structure of the present invention and/or a paper product comprising such fibrous structure is measured as follows. One (1) inch by five (5) inch (2.5 cm×12.7 cm) strips of fibrous structure and/or paper product comprising such fibrous structure are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

“Modulus” or “Tensile Modulus” as used herein means the slope tangent to the load elongation curve taken at the point corresponding to 15 g/cm-width upon conducting a tensile measurement, as specified in the foregoing.

“Peak Load Stretch” (or simply “Stretch”) as used herein is determined by the following formula:

$$\frac{\begin{matrix}Length of Fibrous {Structure}_{PL} - \\ Length of Fibrous {Structure}_{I} \times 100\end{matrix}}{Length of Fibrous {Structure}_{I}}$$

wherein:

Length of Fibrous Structure_{PL} is the length of the fibrous structure at peak load;

Length of Fibrous Structure_{I} is the initial length of the fibrous structure prior to stretching;

The Length of Fibrous Structure_{PL} and Length of Fibrous Structure_{I} are observed while conducting a tensile measurement as specified in the above. The tensile tester calculates the stretch at Peak Load. Basically, the tensile tester calculates the stretches via the formula above.

“Caliper” as used herein means the macroscopic thickness of a sample. Caliper of a sample of fibrous structure according to the present invention is determined by cutting a sample of the fibrous structure such that it is larger in size than a load foot loading surface where the load foot loading surface has a circular surface area of about 3.14 in² (20.3 cm²). The sample is confined between a horizontal flat surface and the load foot loading surface. The load foot loading surface applies a confining pressure to the sample of 15.5 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in millimeters.

“Apparent Density” or “Density” as used herein means the basis weight of a sample divided by the caliper with appropriate conversions incorporated therein. Apparent density used herein has the units g/cm³.

“Softness” of a fibrous structure according to the present invention and/or a paper product comprising such fibrous structure is determined as follows. Ideally, prior to softness testing, the samples to be tested should be conditioned according to Tappi Method #T4020M-88. Here, samples are preconditioned for 24 hours at a relative humidity level of 10 to 35% and within a temperature range of 22° C. to 40° C. After this preconditioning step, samples should be conditioned for 24 hours at a relative humidity of 48% to 52% and within a temperature range of 22° C. to 24° C. Ideally, the softness panel testing should take place within the confines of a constant temperature and humidity room. If this is not feasible, all samples, including the controls, should experience identical environmental exposure conditions.

Softness testing is performed as a paired comparison in a form similar to that described in “Manual on Sensory Testing Methods”, ASTM Special Technical Publication 434, published by the American Society For Testing and Materials 1968 and is incorporated herein by reference. Softness is evaluated by subjective testing using what is referred to as a Paired Difference Test. The method employs a standard external to the test material itself. For tactile perceived softness two samples are presented such that the subject cannot see the samples, and the subject is required to choose one of them on the basis of tactile softness. The result of the test is reported in what is referred to as Panel Score Unit (PSU). With respect to softness testing to obtain the softness data reported herein in PSU, a number of softness panel tests are performed. In each test ten practiced softness judges are asked to rate the relative softness of three sets of paired samples. The pairs of samples are judged one pair at a time by each judge: one sample of each pair being designated X and the other Y. Briefly, each X sample is graded against its paired Y sample as follows:

1. a grade of plus one is given if X is judged to may be a little softer than Y, and a grade of minus one is given if Y is judged to may be a little softer than X;

2. a grade of plus two is given if X is judged to surely be a little softer than Y, and a grade of minus two is given if Y is judged to surely be a little softer than X;

3. a grade of plus three is given to X if it is judged to be a lot softer than Y, and a grade of minus three is given if Y is judged to be a lot softer than X; and, lastly:

4. a grade of plus four is given to X if it is judged to be a whole lot softer than Y, and a grade of minus 4 is given if Y is judged to be a whole lot softer than X.

The grades are averaged and the resultant value is in units of PSU. The resulting data are considered the results of one panel test. If more than one sample pair is evaluated then all sample pairs are rank ordered according to their grades by paired statistical analysis. Then, the rank is shifted up or down in value as required to give a zero PSU value to which ever sample is chosen to be the zero-base standard. The other samples then have plus or minus values as determined by their relative grades with respect to the zero base standard. The number of panel tests performed and averaged is such that about 0.2 PSU represents a significant difference in subjectively perceived softness.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

The fibrous structure and/or sanitary tissue product of the invention may be a single ply web or may be one ply or a multi-ply structure. A multi-ply fibrous structure may be comprised of multiple plies of a fibrous structure of the present invention or of a combination of a plies, at least one of which is a fibrous structure ply of the present invention.

“Fiber Length”, “Average Fiber Length” and “Weighted Average Fiber Length”, are terms used interchangeably herein all intended to represent the “Length Weighted Average Fiber Length” as determined for example by means of a Kajaani FiberLab Fiber Analyzer commercially available from Metso Automation, Kajaani Finland. The instructions supplied with the unit detail the formula used to arrive at this average. The recommended method for measuring fiber length using this instrument is essentially the same as detailed by the manufacturer of the FiberLab in its operation manual. The recommended consistencies for charging to the FiberLab are somewhat lower than recommended by the manufacturer since this gives more reliable operation. Short fiber furnishes, as defined herein, should be diluted to 0.02-0.04% prior to charging to the instrument. Long fiber furnishes, as defined herein, should be diluted to 0.15%-0.30%. Alternatively, fiber length may be determined by sending the short fibers to a contract lab, such as Integrated Paper Services, Appleton, Wis.

“Center of Area” as used herein means a point within the deflection conduit that would coincide with the center of mass of a thin uniform distribution of matter bounded by the periphery of the deflection conduit.

“Major Axis” as used herein means the longest axis crossing the center of area of the deflection conduit and joining two points along the perimeter of the deflection conduit.

“Minor Axis” as used herein means the shortest axis or width crossing the center of area of the deflection conduit and joining two points along the perimeter of the deflection conduit. The minor axis corresponds to the minimum width of the deflection conduit.

“Aspect Ratio” as used herein means the ratio of the machine direction length of a deflection conduit to the cross machine direction length of a deflection conduit.

“Mean Width” as used herein means the conduit is the average length of straight lines drawn through the center of area of the conduit and joining two points on the perimeter thereof.

“Radius of Curvature” as used herein means the instantaneous radius of curvature at a point on a curve.

“Infinite Radius of Curvature” as used herein means the radius of curvature of a straight line in that the point of origin for a curve that yields a straight line must be an infinite distance from the line.

“Negative Radius” as used herein means the radius of curvature of a periphery segment seen as a convex segment from the center of area.

“Positive Radius” as used herein means the radius of a periphery segment seen as a concave segment from the center of area.

“Positively Radiused Deflection Conduit” or “Positively Radiused Dome” as used herein means a deflection conduit or dome having a periphery comprising concave or straight segments as seen from the center of area of the deflection conduit or dome. The positively radiused dome may be optimized with respect to fiber deflection.

“Negatively Radiused Deflection Conduit” or “Negatively Radiused Dome” as used herein means a deflection conduit or dome having a periphery comprising at least one convex segment as seen from the center of area of the deflection conduit or dome. The negatively radiused dome may be non-optimized with respect to fiber deflection.

“Curvilinear” as used herein pertains to curved lines.

“Rectilinear” as used herein pertains to straight lines.

“Z-Direction Height” as used herein means the portion of the resin framework extending from the web facing side of the reinforcing structure.

“Mean Fiber Length” as used herein means the length weighted average fiber length of a fiber slurry or fibrous web.

“Essentially Continuous Network” or “Essentially Continuous Network Region” as used herein means a pattern in which one can connect any two points on or within that pattern by an uninterrupted line running entirely on or within that pattern throughout the line's length. The network is essentially continuous in that minor deviation in the continuity of the network may be tolerated as long as the minor deviations to not significantly affect the performance of the fabric.

“Essentially Semi-Continuous Network” or “Essentially Semi-Continuous Network Region” as used herein means a pattern which has “continuity” in all, but at least one, directions parallel to the X-Y plane, and in which pattern one cannot connect any two points on or within that pattern by an uninterrupted line running entirely on or within that pattern throughout the line's length. Of course, the semi-continuous pattern may have continuity only in one direction parallel to the X-Y plane. The network is essentially semi-continuous in that minor deviation in the semi-continuity of the network may be tolerated as long as the minor deviations to not significantly affect the performance of the fabric.

“Knuckle” as used herein means a region of the fibrous structure that exhibits a value for an intensive property that is different from another region of the fibrous structure and that extends across and/or substantially across the fibrous structure in the MD and/or CD orientation.

“Intensive Property” and/or “Intensive Properties” and/or “Values of Common Intensive Property” and/or “Values of Common Intensive Properties” as used herein means density, basis weight, caliper, substrate thickness, elevation, opacity, crepe frequency, tensile strength and any combination thereof. The fibrous structures of the present invention may comprise two or more regions that exhibit different values of common intensive properties relative to each other. In other words, a fibrous structure of the present invention may comprise one region having a first opacity value and a second region having a second opacity value different from the first opacity value. Such regions may be continuous, substantially continuous and/or discontinuous.

“Product of Caliper and CD Modulus” is a unitless number and is equal to Caliper (in mils units) times CD Modulus (in g/cm units).

“Ratio of CD Modulus to Caliper” is a unitless number and is equal to CD Modulus (in g/cm units) divided by Caliper (in mils units).

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

Fibrous Structure:

The present invention is applicable to fibrous structures in general, including but not limited to conventionally felt-pressed fibrous structures; pattern densified fibrous structures; through-air-dried fibrous structures and high-bulk, uncompacted fibrous structures. The fibrous structures may be of a homogenous or multilayered construction; and the sanitary tissue products made therefrom may be of a single-ply or multi-ply construction.

The fibrous structures of the present invention and/or sanitary tissue products comprising such fibrous structures may have a basis weight of between about 10 g/m² to about 120 g/m² and/or from about 14 g/m² to about 80 g/m² and/or from about 20 g/m² to about 60 g/m².

The fibrous structures of the present invention and/or sanitary tissue products comprising such fibrous structures may have a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in).

The fibrous structures of the present invention and/or sanitary tissue products comprising such fibrous structures may have a density of about 0.60 g/cc or less and/or about 0.30 g/cc or less and/or from about 0.04 g/cc to about 0.20 g/cc.

In one embodiment, the fibrous structure of the present invention is a pattern densified fibrous structure characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Processes for making pattern densified fibrous structures are well known in the art as exemplified in U.S. Pat. Nos. 3,301,746, 3,974,025, 4,191,609 and 4,637,859.

In general, pattern densified fibrous structures are preferably prepared by depositing a papermaking furnish on a foraminous forming wire such as a Fourdrinier wire to form a wet fibrous structure and then juxtaposing the fibrous structure against a three-dimensional substrate comprising an array of supports. The fibrous structure is pressed against the three-dimensional substrate, thereby resulting in densified zones in the fibrous structure at the locations geographically corresponding to the points of contact between the array of supports and the wet fibrous structure. The remainder of the fibrous structure not compressed during this operation is referred to as the high-bulk field. This high-bulk field can be further dedensified by application of fluid pressure, such as with a vacuum type device or a blow-through dryer, or by mechanically pressing the fibrous structure against the array of supports of the three-dimensional substrate. The fibrous structure is dewatered, and optionally predried, in such a manner so as to substantially avoid compression of the high-bulk field. This is preferably accomplished by fluid pressure, such as with a vacuum type device or blow-through dryer, or alternately by mechanically pressing the fibrous structure against an array of supports of the three-dimensional substrate wherein the high-bulk field is not compressed. The operations of dewatering, optional predrying and formation of the densified zones may be integrated or partially integrated to reduce the total number of processing steps performed. Subsequent to formation of the densified zones, dewatering, and optional predrying, the fibrous structure is dried to completion, preferably still avoiding mechanical pressing. Preferably, from about 8% to about 65% of the fibrous structure surface comprises densified knuckles, the knuckles preferably having a relative density of at least 125% of the density of the high-bulk field.

The three-dimensional substrate comprising an array of supports is preferably an imprinting carrier fabric having a patterned displacement of knuckles which operate as the array of supports which facilitate the formation of the densified zones upon application of pressure. The pattern of knuckles constitutes the array of supports previously referred to. Imprinting carrier fabrics are well known in the art as exemplified in U.S. Pat. Nos. 3,301,746, 3,821,068, 3,974,025, 3,573,164, 3,473,576, 4,239,065 and 4,528,239.

In one embodiment, the papermaking furnish is first formed into a wet fibrous structure on a foraminous forming carrier, such as a Fourdrinier wire. The fibrous structure is dewatered and transferred to a three-dimensional substrate (also referred to generally as an “imprinting fabric”). The furnish may alternately be initially deposited on a three-dimensional foraminous supporting carrier. Once formed, the wet fibrous structure is dewatered and, preferably, thermally predried to a selected fiber consistency of between about 40% and about 80%. Dewatering is preferably performed with suction boxes or other vacuum devices or with blow-through dryers. The knuckle imprint of the imprinting fabric is impressed in the fibrous structure as discussed above, prior to drying the fibrous structure to completion. One method for accomplishing this is through application of mechanical pressure. This can be done, for example, by pressing a nip roll which supports the imprinting fabric against the face of a drying drum, such as a Yankee dryer, wherein the fibrous structure is disposed between the nip roll and drying drum. Also, preferably, the fibrous structure is molded against the imprinting fabric prior to completion of drying by application of fluid pressure with a vacuum device such as a suction box, or with a blow-through dryer. Fluid pressure may be applied to induce impression of densified zones during initial dewatering, in a separate, subsequent process stage, or a combination thereof.

Typically, it is this drying/imprinting fabric which induces the structure to have differential density, although other methods of patterned densifying are possible and included within the scope of the invention. Differential density structures may comprise a field of low density with discrete high density areas distributed within the field. They may alternately or further comprise a field of high density with discrete low density areas distributed within that field. It is also possible for a differential density pattern to be strictly composed of discrete elements or regions, i.e. elements or regions which are not continuous. Continuous elements or regions are defined as those which extend to terminate at all edges of the periphery of the repeating unit (or useable unit in the event that the pattern does not repeat within such useable unit).

Most commonly, differential density structures comprise two distinct densities; however, three or more densities are possible and included within the scope of this invention. For purposes of this invention, a region is referred to as a “low density region” if it possesses a density less than the mean density of the entire structure. Likewise, a region is referred to as a “high density region” if it possesses a density greater than the mean density of the entire structure.

The differential density structure of the present invention possesses a “structural aspect ratio”. Physically, this structural aspect ratio relates to the average directionality of the shapes of the discrete areas within the overall field. Note that each discrete area possesses an aspect ratio. The overall structure has an aspect ratio which is the weighted average of each of the individual discrete area aspect ratios. The weighting is done by multiplying the aspect ratio of each discrete region by its respective area, summing all of the products and dividing that sum by the total area of discrete regions. The algorithm for determining structural aspect ratio essentially consists of repeating this process, trying every direction 180° around the structure, until the direction is found which calculates to the highest aspect ratio; this is referred to as the structural aspect ratio and the direction to which it corresponds is referred to as the structural aspect ratio direction.

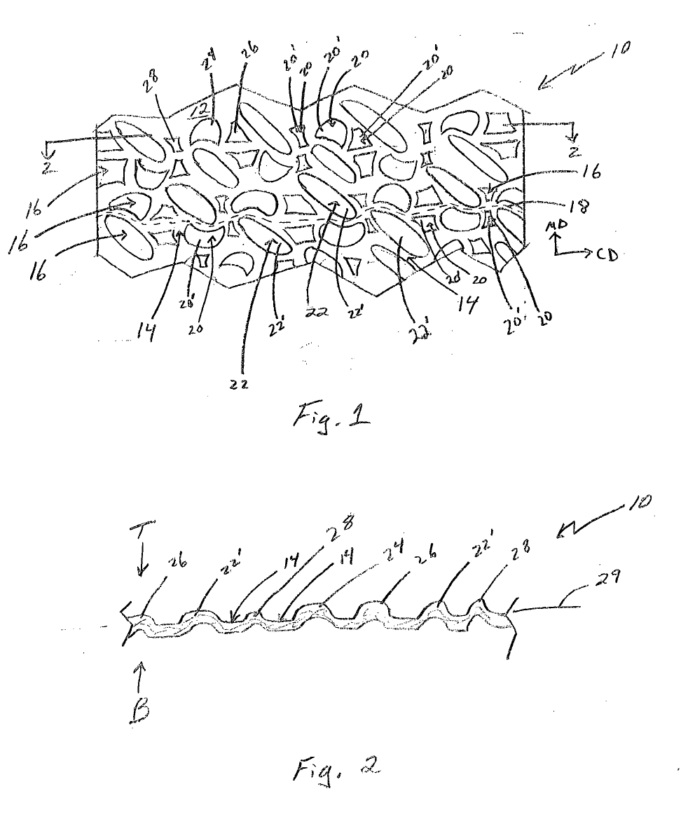

As shown in FIG. 1, in one example of a fibrous structure in accordance with the present invention, a portion of a fibrous structure 10 comprises a surface 12, wherein the surface 12 comprises a network region 14 and a dome region 16. The network region 14, which is referred to as a knuckle, comprises a CD knuckle 18, as represented by the dotted line traversing the fibrous structure 10 in the CD orientation along the network region 14. The dome region 16 comprises a first dome subregion 20 comprising a negatively radiused dome 20′ and a second dome subregion 22 comprising at least two positively radiused domes 22′. The at least two positively radiused domes 22′ are spatially arranged such that their major axes are unaligned.

The CD knuckle 18 may be oriented along the CD axis at an angle of less than 45° and/or less than 35° and/or less than 25° and/or less than 15° and/or less than 10° and/or less than 5° and/or less than 3° and/or about 1° from the CD axis.

The CD knuckle 18 may be substantially linear. “Substantially linear” as used herein means linear or generally linear. For example, the CD knuckle is considered linear unless such deviations along the path of the knuckle away from linear cause the knuckle to be viewed as being non-linear by those of ordinary skill in the art.

The first dome subregion 20 may comprise a first negatively radiused dome 24 and a second negatively radiused dome 26. The first dome subregion 20 may further comprise a third negatively radiused dome 28.

The first negatively radiused dome 24 and second negatively radiused dome 26 exhibit different shapes from one another. The third negatively radiused dome 28 exhibits a different shape from the first and second negatively radiused domes 24, 26.

The network region 14 may exhibit a different value for an intensive property than the dome region 16 and/or the first dome subregion 20 and/or the second dome subregion 22.

The dome region 16 or the first and/or second dome subregions 20, 22 and/or the negatively radiused domes and/or the positively radiused domes may be encompassed by the network region 14.

The network region 14 may exhibit a basis weight that is lower than the basis weight of the first dome subregion 20 and/or the second dome subregion 22.

The network region 14 may exhibit a density that is greater than the density of the first dome subregion 20 and/or the second dome subregion 22.

The network region 14 may exhibit an elevation that is less than the elevation of the negatively radius dome of the first dome subregion and/or at least one of the at least two positively radiused domes of the second dome region.

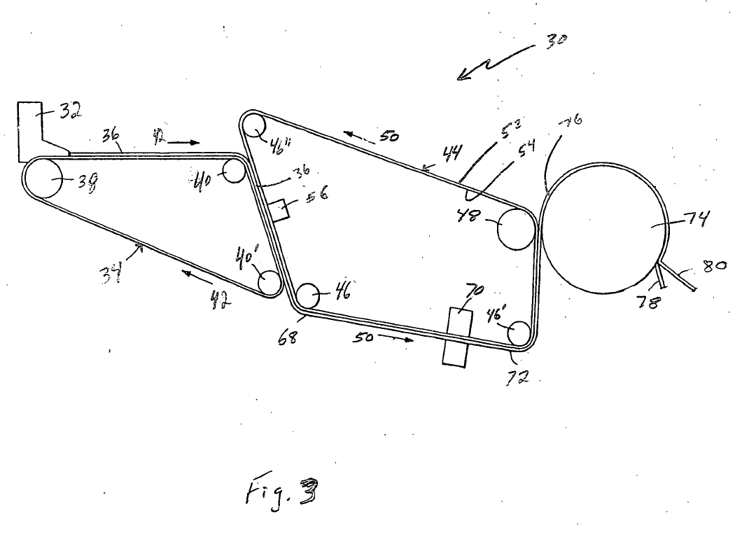

As shown in FIG. 2, which is a partial cross sectional view of the fibrous structure 10 of FIG. 1 taken along line 2-2, the domes appear to extend from (protrude from) a plane 29 of the fibrous structure 10 toward an imaginary observer looking in the direction of arrow T. When viewed by an imaginary observer looking in the direction indicated by arrow B, the domes appear to be cavities or dimples. The portions of the fibrous structure 10 forming the domes can be intact; however, the portions of the fibrous structure 10 forming the domes can comprise one or more holes or openings extending essentially through the fibrous structure 10. Such holes may include holes that are typically referred to as pinholes by those of ordinary skill in the art.

Fibrous Structure Additives

The fibrous structures of the present invention may comprise, in addition to fibers, an optional additive selected from the group consisting of permanent and/or temporary wet strength resins, dry strength resins, wetting agents, lint resisting agents, absorbency-enhancing agents, immobilizing agents, especially in combination with emollient lotion compositions, antiviral agents including organic acids, antibacterial agents, polyol polyesters, antimigration agents, polyhydroxy plasticizers and mixtures thereof. Such optional additives may be added to the fiber furnish, the embryonic fibrous web and/or the fibrous structure.

Such optional additives may be present in the fibrous structures at any level based on the dry weight of the fibrous structure.

The optional additives may be present in the fibrous structures at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

Processes for Making Fibrous Structures

The fibrous structures of the present invention may be made by any suitable process known in the art.

In one example of a process for making a fibrous structure of the present invention, the process comprises the step of contacting an embryonic fibrous web with a deflection member such that at least one portion of the embryonic fibrous web is deflected out-of-plane of another portion of the embryonic fibrous web. The phrase “out-of-plane” as used herein means that the fibrous structure comprises a protuberance, such as a dome, or a cavity that extends away from the plane of the fibrous structure.

In another example of a process for making a fibrous structure of the present invention, the process comprises the steps of:
(a) providing a fibrous furnish comprising fibers; and
(b) depositing the fibrous furnish onto a deflection member such that at least one fiber is deflected out-of-plane of the other fibers present on the deflection member.

In still another example of a process for making a fibrous structure of the present invention, the process comprises the steps of:
(a) providing a fibrous furnish comprising fibers;
(b) depositing the fibrous furnish onto a foraminous member to form an embryonic fibrous web;
(c) associating the embryonic fibrous web with a deflection member such that at least one fiber is deflected out-of-plane of the other fibers present in the embryonic fibrous web; and
(d) drying said embryonic fibrous web such that that the dried fibrous structure is formed.

In another example of a process for making a fibrous structure of the present invention, the process comprises the steps of:

(a) providing a fibrous furnish comprising fibers;

(b) depositing the fibrous furnish onto a first foraminous member such that an embryonic fibrous web is formed;

(c) associating the embryonic web with a second foraminous member which has one surface (the embryonic fibrous web-contacting surface) comprising a macroscopically monoplanar network surface which is continuous and patterned and which defines a first region of deflection conduits and a second region of deflection conduits;

(d) deflecting the fibers in the embryonic fibrous web into the deflection conduits and removing water from the embryonic web through the deflection conduits so as to form an intermediate fibrous web under such conditions that the deflection of fibers is initiated no later than the time at which the water removal through the deflection conduits is initiated; and

(e) optionally, drying the intermediate fibrous web; and

(f) optionally, foreshortening the intermediate fibrous web.

The fibrous structures of the present invention may be made by a process wherein a fibrous furnish is applied to a first foraminous member to produce an embryonic fibrous web. The embryonic fibrous web may then come into contact with a second foraminous member that comprises a deflection member to produce an intermediate fibrous web that comprises a network surface and at least one dome region. The intermediate fibrous web may then be further dried to form a fibrous structure of the present invention.

FIG. 3 is a simplified, schematic representation of one example of a continuous fibrous structure making process and machine useful in the practice of the present invention.

As shown in FIG. 3, one example of a process and equipment, represented as 30 for making a fibrous structure according to the present invention comprises supplying an aqueous dispersion of fibers (a fibrous furnish) to a headbox 32 which can be of any convenient design. From headbox 32 the aqueous dispersion of fibers is delivered to a first foraminous member 34 which is typically a Fourdrinier wire, to produce an embryonic fibrous web 36.

The first foraminous member 34 may be supported by a breast roll 38 and a plurality of return rolls 40, 40′ of which only two are shown. The first foraminous member 34 can be propelled in the direction indicated by directional arrow 42 by a drive means, not shown. Optional auxiliary units and/or devices commonly associated fibrous structure making machines and with the first foraminous member 34, but not shown, include forming boards, hydrofoils, vacuum boxes, tension rolls, support rolls, wire cleaning showers, and the like.

After the aqueous dispersion of fibers is deposited onto the first foraminous member 34, embryonic fibrous web 36 is formed, typically by the removal of a portion of the aqueous dispersing medium by techniques well known to those skilled in the art. Vacuum boxes, forming boards, hydrofoils, and the like are useful in effecting water removal. The embryonic fibrous web 36 may travel with the first foraminous member 34 about return roll 40 and is brought into contact with a deflection member 44, which may also be referred to as a second foraminous member. While in contact with the deflection member 44, the embryonic fibrous web will be deflected, rearranged, and/or further dewatered.

The deflection member 44 may be in the form of an endless belt. In this simplified representation, deflection member 44 passes around and about deflection member return rolls 46, 46′, 46″ and impression nip roll 48 and may travel in the direction indicated by directional arrow 50. Associated with deflection member 44, but not shown, may be various support rolls, other return rolls, cleaning means, drive means, and the like well known to those skilled in the art that may be commonly used in fibrous structure making machines.

Regardless of the physical form which the deflection member 44 takes, whether it is an endless belt as just discussed or some other embodiment such as a stationary plate for use in making handsheets or a rotating drum for use with other types of continuous processes, it must have certain physical characteristics. For example, the deflection member may take a variety of configurations such as belts, drums, flat plates, and the like.

First, the deflection member 44 must be foraminous. That is to say, it must possess continuous passages connecting its first surface 52 (or “upper surface” or “working surface”; i.e. the surface with which the embryonic fibrous web is associated, sometimes referred to as the “embryonic fibrous web-contacting surface”) with its second surface 54 (or “lower surface”; i.e., the surface with which the deflection member return rolls are associated). In other words, the deflection member 44 must be constructed in such a manner that when water is caused to be removed from the embryonic fibrous web 36, as by the application of differential fluid pressure, such as by a vacuum box 56, and when the water is removed from the embryonic fibrous web 36 in the direction of the deflection member 44, the water can be discharged from the system without having to again contact the embryonic fibrous web 36 in either the liquid or the vapor state.

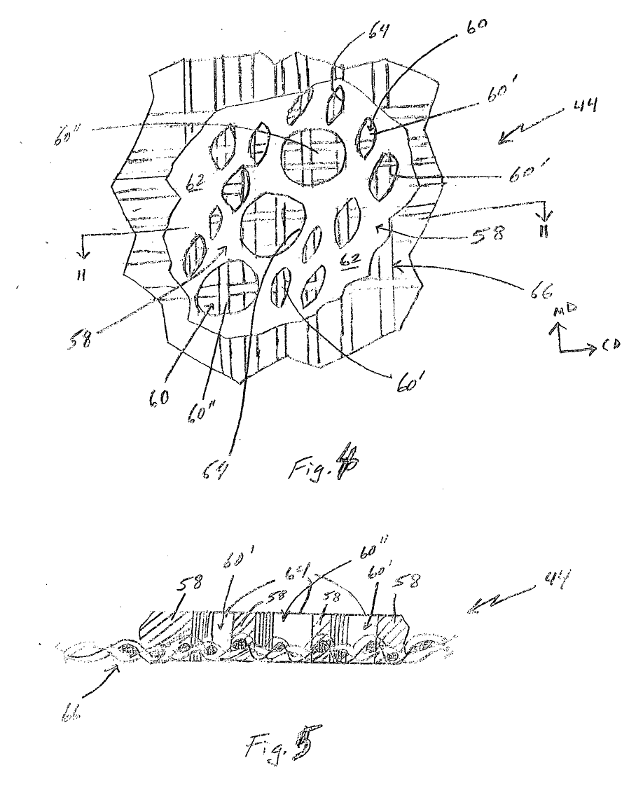

Second, the first surface 52 of the deflection member 44 may comprise a network 58, such as a macroscopically or essentially macroscopically, monoplanar or essentially monoplanar network as represented in one example in FIG. 4. The network 58 may be made by any suitable material. For example, a resin may be used to create the network 58. The network 58 may be continuous, or essentially continuous. The network 58 may be patterned. The network 58 must define within the deflection member 44 a plurality of deflection conduits 60. The deflection conduits 60 may be discrete, isolated, deflection conduits. The network been described as being “macroscopically monoplanar” or “essentially macroscopically monoplanar.” When a surface 62 of the network 58 of the deflection member 44 is placed into a planar configuration, the network surface 62 is essentially monoplanar. It is said to be “essentially” monoplanar to recognize the fact that deviations from absolute planarity are tolerable, but not preferred, so long as the deviations are not substantial enough to adversely affect the performance of the fibrous structure formed on the deflection member 44. The network surface 62 is said to be “continuous” because the areas formed by the network surface 62 must form at least one essentially unbroken net-like pattern. The pattern is said to be “essentially” continuous to recognize the fact that interruptions in the pattern are tolerable, but not preferred, so long as the interruptions are not substantial enough to adversely affect the performance of the fibrous structure made on the deflection member 44.

The deflection conduits 60 of the deflection member 44 may be of any size and shape or configuration. The deflection conduits 60 may repeat in a random pattern or in a uniform pattern. Portions of the deflection member 44 may comprise deflection conduits 60 that repeat in a random pattern and other portions of the deflection member 44 may comprise deflection conduits 60 that repeat in a uniform pattern.

The deflection conduits 60 may comprise two or more classes of deflection conduits. One class of deflection conduits 60′ may translate into (“produce”) the first dome region of a fibrous structure made in accordance with the present invention, for example as shown in FIGS. 3-6. Another class of deflection conduits 60″ may translate into the second dome region of a fibrous structure made in accordance with the present invention, for example as shown in FIGS. 3-6.

The network surface 62 defines openings 64 of the deflection conduits 60.

The network 58 of the deflection member 60 may be associated with a belt, wire or other type of substrate. As shown in FIG. 4, the network 58 of the deflection member 60 is associated with a woven belt 66. Alternatively, the deflection member 44 may consist of solely the network 58. The woven belt 66 may be made by any suitable material, for example polyester, known to those skilled in the art.

As shown in FIG. 5, a cross sectional view of a portion of the deflection member 44 taken along line 5-5 of FIG. 4, the deflection member 44 can be foraminous since the deflection conduits 60 extend completely through the network 58. Further, openings through the deflection member 44 are present in the deflection member 44 since the deflection conduits 60 in combination with interstices present in the woven belt 66 provide openings completely through the deflection member 44.

As shown in FIGS. 4 and 5, the finite shape of the deflection conduits 60 depends on the pattern selected for network surface 62. In other words, the deflection conduits 60 are discretely perimetrically enclosed by network surface 62.

An infinite variety of geometries for the network surface and the openings of the deflection conduits are possible.

Practical shapes of the deflection conduits and/or deflection conduit openings include circles, ovals, and polygons of six or fewer sides. There is no requirement that the openings of the deflection conduits be regular polygons or that the sides of the openings be straight; openings with curved sides, such as trilobal figures, can be used.

In one example of a deflection member in accordance with the present invention, the open area of the deflection member (as measured solely by the open area of the network surface) should be from about 35% to about 85%. The actual dimensions of the open areas of the network surface (in the plane of the surface of the deflection member) can be expressed in terms of effective free span. Effective free span is defined as the area of the opening of the deflection conduit in the plane of the surface of the deflection member divided by one-fourth of the perimeter of the opening of the deflection conduit. Effective free span, for most purposes, should be from about 0.25 to about 3.0 times and/or from about 0.35 to about 2.0 times the average length of the fibers used in the fibrous structure making process.

As discussed thus far, the network surface and deflection conduits can have single coherent geometries. Two or more geometries can be superimposed one on the other to create fibrous structures having different physical and aesthetic properties. For example, the deflection member can comprise first deflection conduits having openings described by a certain shape in a certain pattern and defining a monoplanar network surface all as discussed above. A second network surface can be superimposed on the first. This second network surface can be coplanar with the first and can itself define second conduits of such a size as to include within their ambit one or more whole or fractional first conduits. Alternatively, the second network surface can be noncoplanar with the first. In further variations, the second network surface can itself be nonplanar. In still further variations, the second (the superimposed) network surface can merely describe open or closed figures and not actually be a network at all; it can, in this instance, be either coplanar or noncoplanar with the network surface. It is expected that these latter variations (in which the second network surface does not actually form a network) will be most useful in providing aesthetic character to the paper web. As before, an infinite number of geometries and combinations of geometries are possible.

In one example, the deflection member of the present invention may be an endless belt which can be constructed by, among other methods, a method adapted from techniques used to make stencil screens. By “adapted” it is meant that the broad, overall techniques of making stencil screens are used, but improvements, refinements, and modifications as discussed below are used to make member having significantly greater thickness than the usual stencil screen.

Broadly, a foraminous member (such as a woven belt) is thoroughly coated with a liquid photosensitive polymeric resin to a preselected thickness. A mask or negative incorporating the pattern of the preselected network surface is juxtaposed the liquid photosensitive resin; the resin is then exposed to light of an appropriate wave length through the mask. This exposure to light causes curing of the resin in the exposed areas. Unexpected (and uncured) resin is removed from the system leaving behind the cured resin forming the network defining within it a plurality of deflection conduits.

In another example, the deflection member can be prepared using as the foraminous member, such as a woven belt, of width and length suitable for use on the chosen fibrous structure making machine. The network and the deflection conduits are formed on this woven belt in a series of sections of convenient dimensions in a batchwise manner, i.e. one section at a time. Details of this nonlimiting example of a process for preparing the deflection member follow.

First, a planar forming table is supplied. This forming table is at least as wide as the width of the foraminous woven element and is of any convenient length. It is provided with means for securing a backing film smoothly and tightly to its surface. Suitable means include provision for the application of vacuum through the surface of the forming table, such as a plurality of closely spaced orifices and tensioning means.

A relatively thin, flexible polymeric (such as polypropylene) backing film is placed on the forming table and is secured thereto, as by the application of vacuum or the use of tension. The backing film serves to protect the surface of the forming table and to provide a smooth surface from which the cured photosensitive resins will, later, be readily released. This backing film will form no part of the completed deflection member.

Either the backing film is of a color which absorbs activating light or the backing film is at least semi-transparent and the surface of the forming table absorbs activating light.

A thin film of adhesive, such as 8091 Crown Spray Heavy Duty Adhesive made by Crown Industrial Products Co. of Hebron, Ill., is applied to the exposed surface of the backing film or, alternatively, to the knuckles of the woven belt. A section of the woven belt is then placed in contact with the backing film where it is held in place by the adhesive. The woven belt is under tension at the time it is adhered to the backing film.

Next, the woven belt is coated with liquid photosensitive resin. As used herein, “coated” means that the liquid photosensitive resin is applied to the woven belt where it is carefully worked and manipulated to insure that all the openings (interstices) in the woven belt are filled with resin and that all of the filaments comprising the woven belt are enclosed with the resin as completely as possible. Since the knuckles of the woven belt are in contact with the backing film, it will not be possible to completely encase the whole of each filament with photosensitive resin. Sufficient additional liquid photosensitive resin is applied to the woven belt to form a deflection member having a certain preselected thickness. The deflection member can be from about 0.35 mm (0.014 in.) to about 3.0 mm (0.150 in.) in overall thickness and the network surface can be spaced from about 0.10 mm (0.004 in.) to about 2.54 mm (0.100 in.) from the mean upper surface of the knuckles of the woven belt. Any technique well known to those skilled in the art can be used to control the thickness of the liquid photosensitive resin coating. For example, shims of the appropriate thickness can be provided on either side of the section of deflection member under construction; an excess quantity of liquid photosensitive resin can be applied to the woven belt between the shims; a straight edge resting on the shims and can then be drawn across the surface of the liquid photosensitive resin thereby removing excess material and forming a coating of a uniform thickness.

Suitable photosensitive resins can be readily selected from the many available commercially. They are typically materials, usually polymers, which cure or cross-link under the influence of activating radiation, usually ultraviolet (UV) light. References containing more information about liquid photosensitive resins include Green et al, “Photocross-linkable Resin Systems,” J. Macro. Sci-Revs. Macro. Chem, C21(2), 187-273 (1981-82); Boyer, “A Review of Ultraviolet Curing Technology,” Tappi Paper Synthetics Conf. Proc., Sep. 25-27, 1978, pp 167-172; and Schmidle, “Ultraviolet Curable Flexible Coatings,” J. of Coated Fabrics, 8, 10-20 (July, 1978). All the preceding three references are incorporated herein by reference. In one example, the network is made from the Merigraph series of resins made by Hercules Incorporated of Wilmington, Del.

Once the proper quantity (and thickness) of liquid photosensitive resin is coated on the woven belt, a cover film is optionally applied to the exposed surface of the resin. The cover film, which must be transparent to light of activating wave length, serves primarily to protect the mask from direct contact with the resin.

A mask (or negative) is placed directly on the optional cover film or on the surface of the resin. This mask is formed of any suitable material which can be used to shield or shade certain portions of the liquid photosensitive resin from light while allowing the light to reach other portions of the resin. The design or geometry preselected for the network region is, of course, reproduced in this mask in regions which allow the transmission of light while the geometries preselected for the gross foramina are in regions which are opaque to light.

A rigid member such as a glass cover plate is placed atop the mask and serves to aid in maintaining the upper surface of the photosensitive liquid resin in a planar configuration.

The liquid photosensitive resin is then exposed to light of the appropriate wave length through the cover glass, the mask, and the cover film in such a manner as to initiate the curing of the liquid photosensitive resin in the exposed areas. It is important to note that when the described procedure is followed, resin which would normally be in a shadow cast by a filament, which is usually opaque to activating light, is cured. Curing this particular small mass of resin aids in making the bottom side of the deflection member planar and in isolating one deflection conduit from another.

After exposure, the cover plate, the mask, and the cover film are removed from the system. The resin is sufficiently cured in the exposed areas to allow the woven belt along with the resin to be stripped from the backing film.

Uncured resin is removed from the woven belt by any convenient means such as vacuum removal and aqueous washing.

A section of the deflection member is now essentially in final form. Depending upon the nature of the photosensitive resin and the nature and amount of the radiation previously supplied to it, the remaining, at least partially cured, photosensitive resin can be subjected to further radiation in a post curing operation as required.

The backing film is stripped from the forming table and the process is repeated with another section of the woven belt. Conveniently, the woven belt is divided off into sections of essentially equal and convenient lengths which are numbered serially along its length. Odd numbered sections are sequentially processed to form sections of the deflection member and then even numbered sections are sequentially processed until the entire belt possesses the characteristics required of the deflection member. The woven belt may be maintained under tension at all times.

In the method of construction just described, the knuckles of the woven belt actually form a portion of the bottom surface of the deflection member. The woven belt can be physically spaced from the bottom surface.

Multiple replications of the above described technique can be used to construct deflection members having the more complex geometries.

The deflection member of the present invention may be made or partially made according to U.S. Pat. No. 4,637,859, issued Jan. 20, 1987 to Trokhan.

As shown in FIG. 3, after the embryonic fibrous web 36 has been associated with the deflection member 44, fibers within the embryonic fibrous web 36 are deflected into the deflection conduits present in the deflection member 44. In one example of this process step, there is essentially no water removal from the embryonic fibrous web 36 through the deflection conduits after the embryonic fibrous web 36 has been associated with the deflection member 44 but prior to the deflecting of the fibers into the deflection conduits. Further water removal from the embryonic fibrous web 36 can occur during and/or after the time the fibers are being deflected into the deflection conduits. Water removal from the embryonic fibrous web 36 may continue until the consistency of the embryonic fibrous web 36 associated with deflection member 44 is increased to from about 25% to about 35%. Once this consistency of the embryonic fibrous web 36 is achieved, then the embryonic fibrous web 36 is referred to as an intermediate fibrous web 68. During the process of forming the embryonic fibrous web 36, sufficient water may be removed, such as by a noncompressive process, from the embryonic fibrous web 36 before it becomes associated with the deflection member 44 so that the consistency of the embryonic fibrous web 36 may be from about 10% to about 30%.

While applicants decline to be bound by any particular theory of operation, it appears that the deflection of the fibers in the embryonic web and water removal from the embryonic web begin essentially simultaneously. Embodiments can, however, be envisioned wherein deflection and water removal are sequential operations. Under the influence of the applied differential fluid pressure, for example, the fibers may be deflected into the deflection conduit with an attendant rearrangement of the fibers. Water removal may occur with a continued rearrangement of fibers. Deflection of the fibers, and of the embryonic fibrous web, may cause an apparent increase in surface area of the embryonic fibrous web. Further, the rearrangement of fibers may appear to cause a rearrangement in the spaces or capillaries existing between and/or among fibers.

It is believed that the rearrangement of the fibers can take one of two modes dependent on a number of factors such as, for example, fiber length. The free ends of longer fibers can be merely bent in the space defined by the deflection conduit while the opposite ends are restrained in the region of the network surfaces. Shorter fibers, on the other hand, can actually be transported from the region of the network surfaces into the deflection conduit (The fibers in the deflection conduits will also be rearranged relative to one another). Naturally, it is possible for both modes of rearrangement to occur simultaneously.

As noted, water removal occurs both during and after deflection; this water removal may result in a decrease in fiber mobility in the embryonic fibrous web. This decrease in fiber mobility may tend to fix and/or freeze the fibers in place after they have been deflected and rearranged. Of course, the drying of the web in a later step in the process of this invention serves to more firmly fix and/or freeze the fibers in position.

Any convenient means conventionally known in the papermaking art can be used to dry the intermediate fibrous web 68. Examples of such suitable drying process include subjecting the intermediate fibrous web 68 to conventional and/or flow-through dryers and/or Yankee dryers.

In one example of a drying process, the intermediate fibrous web 68 in association with the deflection member 44 passes around the deflection member return roll 46 and travels in the direction indicated by directional arrow 50. The intermediate fibrous web 68 may first pass through an optional predryer 70. This predryer 70 can be a conventional flow-through dryer (hot air dryer) well known to those skilled in the art. Optionally, the predryer 70 can be a so-called capillary dewatering apparatus. In such an apparatus, the intermediate fibrous web 68 passes over a sector of a cylinder having preferential-capillary-size pores through its cylindrical-shaped porous cover. Optionally, the predryer 70 can be a combination capillary dewatering apparatus and flow-through dryer.

The quantity of water removed in the predryer 70 may be controlled so that a predried fibrous web 72 exiting the predryer 70 has a consistency of from about 30% to about 98%.

The predried fibrous web 72, which may still be associated with deflection member 44, may pass around another deflection member return roll 72 and as it travels to an impression nip roll 48. As the predried fibrous web 72 passes through the nip formed between impression nip roll 48 and a surface of the Yankee dryer 74, the network pattern formed by the top surface 52 of deflection member 44 is impressed into the predried fibrous web 72 to form an imprinted fibrous web 76. The imprinted fibrous web 76 can then be adhered to the surface of the Yankee dryer 74 where it can be dried to a consistency of at least about 95%.

The imprinted fibrous web 76 can then be foreshortened by creping the imprinted fibrous web 76 with a creping blade 78 to remove the imprinted fibrous web 76 from the surface of the Yankee dryer 74 resulting in the production of a fibrous structure 80 in accordance with the present invention. As used herein, foreshortening refers to the reduction in length of a dry (having a consistency of at least about 90% and/or at least about 95%) fibrous web which occurs when energy is applied to the dry fibrous web in such a way that the length of the fibrous web is reduced and the fibers in the fibrous web are rearranged with an accompanying disruption of fiber-fiber bonds. Foreshortening can be accomplished in any of several well-known ways. One common method of foreshortening is creping.

Since the network region and the domes are physically associated in the web, a direct effect on the network region must have, and does have, an indirect effect on the domes. In general, the effects produced by creping on the network region (the higher density regions) and the domes (the lower density regions) of the web are different. It is presently believed that one of the most notable differences is an exaggeration of strength properties between the network region and the domes. That is to say, since creping destroys fiber-fiber bonds, the tensile strength of a creped web is reduced. It appears that in the web of the present invention, while the tensile strength of the network region is reduced by creping, the tensile strength of the dome is concurrently reduced a relatively greater extent. Thus, the difference in tensile strength between the network region and the domes appears to be exaggerated by creping. Differences in other properties can also be exaggerated depending on the particular fibers used in the web and the network region and dome geometries.

Lastly, the fibrous structure 80 may be subjected to post processing steps such as calendering and/or embossing and/or converting.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising:
a. a network region; and
b. a dome region;
wherein the network region comprises a CD knuckle.

2. The fibrous structure according to claim 1 wherein the dome region comprises a first dome subregion comprising a negatively radiused dome and a second dome subregion comprising at least two positively radiused domes.

3. The fibrous structure according to claim 2 wherein each of the at least two positively radiused domes have a major axis, wherein the at least two positively radiused domes are spatially arranged such that their major axes are unaligned.

4. The fibrous structure according to claim 2 wherein the negatively radiused dome comprises at least one positively radiused side of the dome.

5. The fibrous structure according to claim 2 wherein the first dome subregion comprises a first negatively radiused dome and a second negatively radiused dome, wherein the first negatively radiused dome exhibits a different shape than the second negatively radiused dome.

6. The fibrous structure according to claim 5 wherein the first dome subregion further comprises a third negatively radiused dome that exhibits a different shape than both the first and second negatively radiused domes.

7. The fibrous structure according to claim 2 wherein the network region exhibits a different value for an intensive property than the first dome subregion and/or the second dome subregion.

8. The fibrous structure according to claim 2 wherein the negatively radiused dome of the first dome subregion is encompassed by the network region.

9. The fibrous structure according to claim 2 wherein at least one of the positively radiused domes of the second dome subregion is encompassed by the network region.

10. The fibrous structure according to claim 2 wherein the negatively radiused dome of the first dome subregion is separated from at least one of the at least two positively radiused domes of the second dome subregion by the network region.

11. The fibrous structure according to claim 2 wherein the network region exhibits a basis weight that is lower than the basis weight of the first dome subregion and/or the second dome subregion.

12. The fibrous structure according to claim 2 wherein the network region exhibits a density that is higher than the density of the first dome subregion and/or the second dome subregion.

13. The fibrous structure according to claim 2 wherein the network region exhibits an elevation that is less than the elevation of the negatively radiused dome of the first dome subregion and/or at least one of the at least two positively radiused domes of the second dome subregion.

14. The fibrous structure according to claim 1 wherein the fibrous structure exhibits a caliper and a CD modulus such that the product of the caliper and the CD modulus is greater than about 30,000.

15. The fibrous structure according to claim 14 wherein the fibrous structure is a through-air-dried fibrous structure.

16. The fibrous structure according to claim 14 wherein the fibrous structure is a pattern densified fibrous structure.

17. A single- or multi-ply sanitary tissue product comprising a fibrous structure according to claim 1.

18. A fibrous structure comprising a caliper and a CD modulus such that the product of the caliper and the CD modulus is greater than about 10,000.

19. A single- or multi-ply sanitary tissue product comprising a fibrous structure according to claim 18.

20. A fibrous structure comprising a ratio of CD modulus to caliper of at least about 35.

21. A single- or multi-ply sanitary tissue product comprising a fibrous structure according to claim 20.
